(19) United States
(12) Patent Application Publication
(10) Pub. No.: US 2017/0341822 A1
(43) Pub. Date: Nov. 30, 2017

(54) DEVICE FOR SEALING A CONTAINER COMPRISING A NECK

(71) Applicant: COMMISSARIAT A L'ENERGIE ATOMIQUE ET AUX ENERGIES ALTERNATIVES, Paris (FR)

(72) Inventor: Abderrahman Essebbar, Nice (FR)

(73) Assignee: COMMISSARIAT A L'ENERGIE ATOMIQUE ET AUX ENERGIES ALTERNATIVES, Paris (FR)

(21) Appl. No.: 15/537,533

(22) PCT Filed: Dec. 22, 2015
(86) PCT No.: PCT/FR2015/053713

§ 371 Date: Jun. 19, 2017

(30) Foreign Application Priority Data
Dec. 29, 2014 (FR) 1463369

(51) Int. Cl. B65D 39/00; B65D 55/02; G08B 13/24; G06K 19/077

(52) U.S. Cl. CPC B65D 39/0058; G06K 19/07798; B65D 55/028; B65D 39/0076; G08B 13/2434; G08B 13/2417; B65D 2203/10; B65D 2101/00; H04Q 2209/47

(57) ABSTRACT

The invention relates to a device (100) for sealing a container having a neck, said device comprising:
a deformable portion (1) intended to be at least partially arranged inside the neck of the container so as to seal it in a leak tight manner, said portion being capable of deforming elastically when inserted into the neck, said portion comprising a first end intended to be oriented towards the inside of the container, and
a radiofrequency identification tag (11),
said device being characterised in that it comprises at least one piezoelectric component (10) electrically connected to the tag (11) and arranged inside said deformable portion (1), within a blind recess on the first end side, generating an electric voltage caused by expansion of the deformable portion containing the piezoelectric component when said deformable portion is removed from the neck, said electric voltage being capable of causing a change of state of the radiofrequency identification tag.

### FIELD OF THE INVENTION

The present invention relates to a device for sealing a container comprising a neck, as well as a system for detecting the opening of a container, the neck of which is sealed by such a device.

### BACKGROUND OF THE INVENTION

Certain liquids, mainly liquids of great value—such as spirits for example, or instead medicines—are regularly subject to counterfeiting.

To this end, the counterfeiter procures a container having contained the original liquid, fills it with a liquid of lower quality and reseals the container by means of a stopper, potentially the original stopper.

If this re-stoppering operation has been implemented with sufficient care, it may not be visible for the subsequent consumer.

Systems based on radiofrequency identification (RFID) have been developed in order to enable fraudulent re-stoppering of a container to be highlighted. These systems implement a device, also called tag hereafter, comprising an electronic chip and an antenna, arranged on a thin support. Generally, in these systems, the tag is mechanically damaged when the container is opened. The tags are often visible from the outside of the container and are easy to reproduce by an ill-intentioned person. Notably, the document US2009/102664 proposes inserting inside the stopper a RFID chip and its antenna, connected by a connection arranged in such a way as to be broken when the stopper is opened by the penetration of a corkscrew.

To operate, the radiofrequency identification tag has to be supplied with energy.

In so far as the traceability of the opening of the container has to be able to be guaranteed for several years, the energy source has to remain operational throughout this duration.

A battery embedded in the stopper does not constitute a satisfactory solution on account of its bulk, which makes it difficult to integrate in a stopper of restricted volume, due to the fact that its durability is not guaranteed over such long periods, and its cost.

The patent U.S. Pat. No. 8,040,244 proposes a stopper in which a radiofrequency identification device and a piezoelectric element are integrated. The piezoelectric element is positioned in a recess which is formed, in the stopper, on the inside side of the container. When the stopper is removed from the container, due to the fact of the pressure difference between the inside of the bottle and the outside, the piezoelectric element deforms and supplies the passive RFID chip; a recording of the opening may be provided in the RFID chip. This technique has the drawback that it involves forming a cavity in the stopper directly in contact with the liquid, the piezoelectric element being able to be in contact with said liquid, which is generally not desired.

### BRIEF DESCRIPTION OF THE INVENTION

An aim of the invention is to design a sealing device comprising a radiofrequency identification tag, as well as an element making it possible to modify the state of the tag when the container is first opened that is reliable and durable over time and which does not have the drawbacks of the prior art. More particularly, this modification of the state of the tag may be a damaging thereof, or instead a recording in a memory of the tag of information relative to the opening of the container, as will be described hereafter. Said sealing device must be able to replace a conventional stopper and must consequently reproduce the shape and the dimensions of such a stopper.

In accordance with the invention, a device for sealing a container having a neck is proposed, said device comprising:

a deformable portion intended to be at least partially arranged inside the neck of the container so as to seal it in a leak tight manner, said portion being capable of deforming elastically when inserted into the neck, said portion comprising a first end intended to be oriented towards the interior of the container, and

a radiofrequency identification tag,
said device being characterised in that it comprises at least one piezoelectric component electrically connected to the tag and arranged inside said deformable portion, within a blind recess on the first end side, generating an electric voltage caused by an expansion of the deformable portion containing the piezoelectric component when said deformable portion is removed from the neck, said electric voltage being capable of causing a change of state of the radiofrequency identification tag.

According to an embodiment of the invention, the piezoelectric component is configured so that the electric voltage that it generates when the deformable portion is removed damages the radiofrequency identification tag.

According to another embodiment of the invention, the piezoelectric component is configured so that the electric voltage that it generates when the deformable portion is removed increments a counter of the radiofrequency identification tag or modifies a value of a bit of a memory comprised in the tag.

According to an embodiment, said piezoelectric component has the shape of a strip.

Advantageously, the deformable portion has a cylindrical shape and the piezoelectric strip extends in a plane comprising the longitudinal axis of said cylinder.

Furthermore, the device may comprise a diode electrically connected to the piezoelectric component and to the tag so as to only allow to pass to the radiofrequency identification tag the electric current generated when the deformable portion is removed from the neck.

The deformable portion of the device may be made of cork, an expanded plastic material or an agglomerated material.

According to an embodiment, the device comprises a cap integral with the deformable portion and the radiofrequency identification tag is arranged in said cap.

According to an embodiment, the sealing device comprises several piezoelectric components electrically connected to the tag.

The invention also relates to a system for detecting the opening of a container having a neck sealed by a sealing device as described above, comprising a mobile reader coupled to the radiofrequency identification tag.

### BRIEF DESCRIPTION OF THE DRAWINGS

Other characteristics and advantages of the invention will become clear from the detailed description that follows, with reference to the appended drawings in which:

FIG. 1 is an outline schematic of a first embodiment of a sealing device according to the invention,

FIG. 2 is an outline schematic of a second embodiment of a sealing device according to the invention,

FIG. 3 is an outline schematic of a third embodiment of a sealing device according to the invention.

### DETAILED DESCRIPTION OF THE INVENTION

In order to be inserted into the neck of a bottle, wine or spirit stoppers are compressed. During this insertion, their volume is reduced by between 20% and 30%. On opening the bottle, the stopper can recover up to 95% of its initial volume by elasticity.

The sealing device proposed herein as a replacement for a stopper or conventional device for sealing a container comprises a portion intended to be at least partially arranged inside the neck of the container so as to seal it in a leak tight manner. This portion arranged inside the neck is capable of deforming elastically when inserted into the neck or when removed from the neck.

The device further comprises a radiofrequency identification tag constituted of a RFID chip and an antenna, the general state of which is modified when the container is first opened. Said tag may be arranged directly in the stopper, or be positioned on the surface thereof.

In the remainder of this description, it will be noted that radiofrequency identification tag is taken to mean any passive radiofrequency identification device, that is to say not comprising a specific energy storage system, and thus not being a signal emitting source. However, it is considered herein that the chip present in the RFID tag may be more or less complex, ranging from a chip that simply sends a digital identification to a reader, without possible modification of this identification over time, to a chip associated with a re-inscribable memory and/or to a processing module. In the latter case, the processing module can, in response to a determined signal, modify a value in the memory.

The device finally comprises a piezoelectric component arranged in a recess inside said deformable portion so as to generate an electric voltage when said deformable portion is inserted into the neck of the container or when said deformable portion is removed from the neck. On the end side of the deformable portion intended to be oriented towards the inside of the container, said recess is blind, which prevents any contact between the contents of the container and the piezoelectric component. Thus, the perception of a user vis-a-vis the device according to the invention is identical to that of a conventional stopper, the piezoelectric component not being able to alter the contents of the container. An electrical connection is provided between the piezoelectric component and the radiofrequency identification tag in such a way that the generation of an electric voltage by the piezoelectric component, resulting from an expansion of the deformable portion when the stopper is extracted from the container, is used to modify the state of the tag. Modification of the state of the tag is herein taken to mean a damaging thereof (either at the level of the antenna or at the level of the chip of the tag), or a recording in a memory of the tag of information relative to the opening of the container (for example a change of the state of a bit of the memory . . . ).

The invention is thus based on the recovery of the energy accumulated in the elastically deformable portion of the sealing device when it is inserted into the neck of the container. This energy is released in the form of an expansion of the deformable portion of the sealing device when it is removed from the neck. Consequently, the piezoelectric component arranged in this deformable portion generates an electric voltage of the order of ten or so volts. This electric voltage may be used either to register information in a memory of the tag, or to damage it.

In a manner known per se, the radiofrequency identification tag comprises a chip and an antenna. Preferably, the chip and its antenna are of reduced size for integration in the stopper or in a cap formed on the stopper.

A mobile reader external to the sealing device makes it possible to communicate with the radiofrequency identification tag and to read the information registered in the chip. In a manner known per se, said reader may be a tablet, a smartphone (for example in the case where the radiofrequency identification tag is of Near Field Communication (NFC) type), a mobile personal assistant, or instead a rugged mobile logistic device.

According to an embodiment, the piezoelectric element is coupled, directly or not, by means of electric wires, to the antenna of the radiofrequency identification tag. The electric voltage generated by the opening of the container then makes it possible to damage the antenna and thus to deactivate the radiofrequency identification tag. Damaging the antenna is taken to mean for example the electrical disconnection thereof from the electronic chip that is associated therewith. To do so, a fuse can be placed between the antenna and the electronic chip.

According to another embodiment, the piezoelectric element is coupled by electrical wires to the chip of the radiofrequency identification tag. According to an embodiment of the invention, the electric voltage generated by the opening of the container makes it possible to damage the chip and thus to deactivate the radiofrequency identification tag.

According to another embodiment of the invention, in order to continue to read the information registered in the chip, the electric voltage generated is not destructive but makes it possible to register proof of opening in a memory.

For example, the appearance of an electric voltage on the piezoelectric element may involve the reversal of a bit in the memory associated with the electronic chip. During the reading of the radiofrequency identification device, the value of this bit is read and makes it possible to detect if the obstruction device has been extracted from the neck of the container.

It is also possible to provide that the radiofrequency identification device is associated with a microcontroller comprising a non-volatile memory in which is stored a value that is incremented at each opening and/or closing of the container. The reading of the radiofrequency identification device is then provided to report to the reader the value stored in the non-volatile memory. In this latter alternative embodiment, a counter may also be provided to store information on the number of openings and/or closings of the container.

In so far as the compression of the deformable portion of the sealing device when it is first inserted into the neck is able to generate the appearance of an electric voltage of sense opposite to the voltage generated when the container is opened, which could damage the radiofrequency identification tag, the device proposed herein may further comprise a diode, so as to transmit to the tag only the energy released when the container is opened.

The piezoelectric component has the advantage of having a small bulk which makes it possible to integrate it easily in a sealing device of reduced volume.

Thus, for example, the piezoelectric component may be in the form of a strip of several tenths of mm thickness and/or ten or so mm diameter. It will be noted that the cylindrical shape of the piezoelectric component is not limiting, and that any other shape could be provided.

Furthermore, such a piezoelectric component is commercially available at low cost, such that it does not put a strain on the manufacturing of the sealing device.

Any piezoelectric material may be employed. Quartz, PZT ceramic, or instead poly vinylidene fluoride (PVDF) could also notably be cited.

Those skilled in the art will be able to determine the dimensions of the piezoelectric component as a function of the piezoelectric material chosen, the material of the deformable portion and the size of the stopper.

Generally, the deformable portion intended to be inserted into the neck is of cylindrical shape.

To recover the maximum of energy on either side of the piezoelectric component, it is preferably arranged in a plane comprising the longitudinal axis of the cylindrical deformable portion. A layout according to an orthogonal plane is however also possible.

Among the materials envisaged for the deformable portion, namely solid cork, agglomerated cork and expanded plastic, it is solid cork that has the lowest elasticity and which is thus the least favourable for the implementation of the invention. Preferably, agglomerated cork and expanded plastic will thus be chosen, which further make it possible to integrate the piezoelectric component during the moulding of the deformable portion.

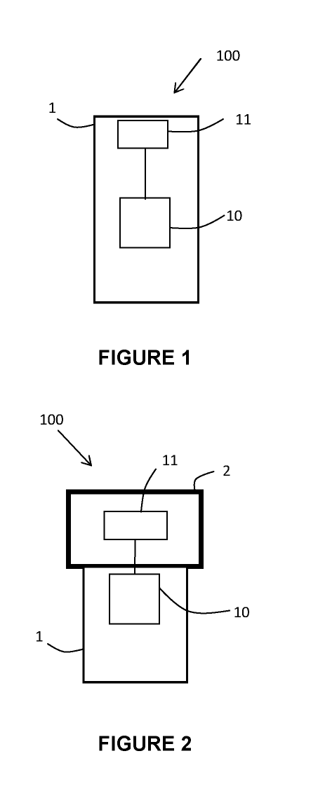

FIG. 1 illustrates an embodiment of a sealing device 100 constituted uniquely of the elastically deformable portion 1, such as a wine stopper.

The piezoelectric component 10 is a strip arranged in a plane comprising the longitudinal axis of the stopper. In this example, the radiofrequency identification tag 11 is also integrated in the stopper. It will be noted that the tag may also be placed on the surface of the stopper if this is desired.

FIG. 2 illustrates an embodiment of a sealing device 100 comprising a cap 2 integral with the deformable portion 1, such as a spirits stopper. Only the deformable portion 1, which has for example a cylindrical shape, is intended to be inserted into the neck of the container, the cap 2, larger than the deformable portion, being intended to rest on the edge of the neck.

In this example, the piezoelectric component 10 is a strip arranged in a plane comprising the longitudinal axis of the cylindrical deformable portion 1. The radiofrequency identification device 11 is arranged in the cap 2.

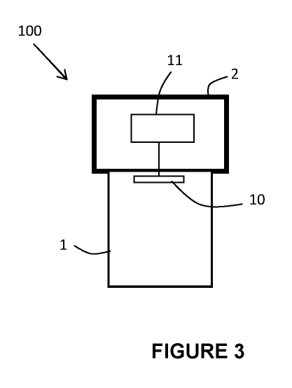

FIG. 3 illustrates another embodiment of a sealing device 100 similar to that of FIG. 2, that is to say comprising a cap 2 integral with a deformable portion 1. In this example, the piezoelectric component 10 is a strip arranged in a plane comprising the transversal axis of the cylindrical deformable portion 1. An advantage of this embodiment is that it enables an easy integration of the piezoelectric element relatively near to the cap, and by using the deformation generated by the force exerted on the cap.

Finally, it goes without saying that the examples that have been given are only particular illustrations that are in no way limiting with regard to the fields of application of the invention.

In particular, apart from drinks such as wines or spirits, the container may contain any other liquid or a solid, for example chemicals or medicines.

Advantageously, the sealing device proposed herein has an external shape similar to sealing devices of the prior art, which enables an easy substitution in conventional devices. Moreover, as regards the portion of the sealing device intended to be, once inserted into the container, on the inside side of the container, the shape is identical to conventional devices, which avoids the drawbacks of the prior art in which this portion is modified to integrate the piezoelectric component on the side of the container.

Moreover, although the presence of a single piezoelectric element integrated in the sealing device has been mentioned herein, it will be noted that several piezoelectric element of suitable sizes, connected in series or in parallel, could also be provided if desired. The use of bimorph piezoelectric strips could also be provided if desired.

1. A device for sealing a container having a neck, said device comprising:
a deformable portion intended to be at least partially arranged inside the neck of the container so as to seal it in a leak tight manner, said portion being capable of deforming elastically when inserted into the neck, said portion comprising a first end intended to be oriented towards the inside of the container, and
a radiofrequency identification tag,
said device further comprising at least one piezoelectric component electrically connected to the tag and arranged inside said deformable portion, within a blind recess on the first end side, the at least one piezoelectric component generating an electric voltage caused by an expansion of the deformable portion containing the piezoelectric component when said deformable portion is removed from the neck, said electric voltage being capable of causing a change of state of the radiofrequency identification tag.

2. The device according to claim 1, wherein the at least one piezoelectric component is configured so that the electric voltage generated when the deformable portion is removed damages the radiofrequency identification tag.

3. The device according to claim 1, wherein the at least one piezoelectric component is configured so that the electric voltage generated when the deformable portion is removed increments a counter of the radiofrequency identification tag or modifies a value of a bit of a memory comprised in the tag.

4. The device according to claim 1, wherein the at least one piezoelectric component has the shape of a strip.

5. The device according to claim 4, wherein the deformable portion has a cylindrical shape and in that the piezoelectric strip extends in a plane comprising the longitudinal axis of said cylinder.

6. The device according to claim 1, further comprising a diode electrically connected to the piezoelectric component and to the tag so as to only allow to pass to the radiofrequency identification tag the electric current generated when the deformable portion is removed from the neck.

7. The device according to claim 1, wherein the deformable portion is made of cork.

8. The device according to claim 1, wherein the deformable portion is made of an expanded plastic material.

9. The device according to claim 1, wherein the deformable portion is made of an agglomerated material.

10. The device according to claim 1, further comprising a cap integral with the deformable portion, the radiofrequency identification tag being arranged in said cap.

11. The device according to claim 1, comprising several piezoelectric components electrically connected to the tag.

12. A system for detecting opening of a container having a neck sealed by a sealing device according to claim 1, comprising a mobile reader coupled to the radiofrequency identification tag.
